(19) United States
(12) Patent Application Publication
(10) Pub. No.: US 2010/0088980 A1
(43) Pub. Date: Apr. 15, 2010

(54) SEISMIC ISOLATOR AND METHOD TO PRODUCE SAID SEISMIC ISOLATOR

(75) Inventors: Gaetano Russo, Udine (IT); Paolo Angeli, Udine (IT); Igino Pitacco, Udine (IT); Margherita Pauletta, Tavagnacco (IT); Abramo Paschini, Verzegnis (IT)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: UNIVERSITA' DEGLI STUDI DI UDINE, Udine (IT)

(21) Appl. No.: 12/526,965

(22) PCT Filed: Feb. 14, 2009
(86) PCT No.: PCT/EP08/51779

§ 371 Date: Aug. 13, 2009

(30) Foreign Application Priority Data
Feb. 14, 2007 (IT) UD2007A000032

(51) Int. Cl. E04B 1/98; B29C 70/30

(52) U.S. Cl. 52/167.7; 156/245

(57) ABSTRACT

A seismic isolator includes at least two layers disposed one on top of the other and made of an elastomer material and at least a reinforcement element in the form of a sheet, disposed between the layers and made of fibers.

### FIELD OF THE INVENTION

The present invention concerns a seismic isolator based on an elastomer material reinforced with layers of fibers, so as to form a sheet, that are substantially free of stiffness to flexional and compressive forces, which can be used to protect buildings from seismic actions. In particular, the isolator is disposed between the substructure, or foundations, and the superstructure, or elevated structure, of a building, in order to reduce the seismic forces absorbed by the superstructure and therefore reduce the consequences and damage deriving from a seismic event.

The connection between the isolator and, respectively, the substructure and the superstructure is obtained by friction only, and it does not need any anchorage device.

### BACKGROUND OF THE INVENTION

It is known that there are substantially two approaches to be followed in order to protect a building subject to seismic events of high intensity.

A first approach, of the traditional type, provides to make adequately rigid buildings, resistant, ductile and able to sustain deformations without structural collapse and therefore, without causing loss of human life.

A second approach, more innovative, consists in reducing the actions that act on the elevated structure. Within the framework of this second approach it is provided to use structural elements, so-called seismic isolators, which are interposed between the superstructure and the substructure of the building.

These structural devices are formed by layers of elastomer material, like natural or artificial rubber, alternating with thinner, steel plates. The combination of these layers and plates, superimposed and alternating, is delimited at the top and bottom by thick steel plates, which connect the isolator respectively to the substructure and superstructure of the building.

When the isolator is compressed, the horizontal sections of elastomer dilate in their plane, and at the same time the steel plates prevent the layer of elastomer from dilating excessively. By reducing this dilation, the steel plates reduce the vertical deformability of the isolator, that is, they confer rigidity in the vertical direction. The layers of elastomer allow the isolators to deform considerably under horizontal actions, and the greater flexibility of the building deriving from this confers on the insulated structure a much lower main frequency than it would have if it had a fixed base, and consequently the accelerations that act on the insulated structure are much lower than those transmitted by the ground.

While the non-insulated structure deforms, due to the effect of the earthquake on all levels, mainly with horizontal translations and plane rotations, the insulated structure sustains significant displacements only between the substructure and superstructure. Thus the superstructure remains almost undeformed, and is therefore scarcely affected by the earthquake. Consequently, the non-structural elements connected to the structure also sustain very limited deformations, and the functionality of the buildings is preserved. This also gives a high level of safety to the persons occupying the building.

The use of seismic isolators, on a theoretical and scientific level, has found a certain application in the protection of buildings, bridges and industrial structures of particular strategic or cultural importance, or with a particular use, such as for example medical emergency centers, hospitals, fire stations, museums, historical buildings, or again buildings that host apparatuses that are sensitive to horizontal accelerations, such as telecommunication centers, data processing centers, microchip production centers. This use, however, is limited due to the considerable weight of the isolators, determined by the steel plates, the complex installation and the high costs which using known isolators entails. This has caused an extremely limited use of seismic isolation as a method of protection for buildings used for civilian inhabitation.

One known and alternative solution to the one described above, disclosed in WO 98/57013, provides to make an isolator consisting of unitary cells formed by layers of elastomer incorporating elongated pre-tensioned fibers of Kevlar or carbon. The cells are pre-assembled, stacked and vulcanized together and subsequently are connected to the substructure and superstructure by means of steel plates, structural wood plates or by means of epoxy type structural glues.

This solution, although it is lighter than the previous one, has very high production costs, due above all to the laborious operation of pre-tensioning the fibers.

Another known solution is disclosed in FR 2 736 114 A, in which the reinforcement means are comprised of pieces of used tires already containing inside a metal armature. This reinforcement means are located inside a mold, alternate to rubber layers and vulcanized together. In this solution, too, the so obtained isolator is provided with end plates in order to anchor it to the remainder of the structure.

Other isolating systems are known which employ carbon fibers as reinforcement means. One of these systems is disclosed in US 2004/0123530, in which elastomeric layers are located below the resting zone of a tank and these elastomeric layers are alternated to elastomeric foils inside which carbon fibers are embedded. In this case, too, the reinforcement elastomeric foils are subjected to a pre-treatment process in order to embed the fibers inside them.

As a matter of fact, all the known solutions which make use of carbon fibers in order to reinforce the elastomeric structure of the isolator provide to embed the fibers, already pre-tensioned, inside the elastic elements in order to increase their stiffness.

One purpose of the present invention is to achieve a seismic isolator which is effective to protect a building from a seismic event and which is light and inexpensive.

Another purpose of the present invention is to achieve an isolator which can be shaped and/or cut to size, also into several parts, both in production and also, subsequently, during installation, also in elongated form, so that it can be used under columns and masonry of various thickness and length.

A further purpose of the present invention is to make faster, easier and cheaper the manufacturing process of the isolator.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with said purposes a seismic isolator according to the present invention comprises a plurality of layers disposed one above the other and made of an elastomer material.

According to a characteristic feature of the present invention, the isolator also comprises at least a plane reinforcement element, in sheet form, advantageously a plurality, disposed alternating with said layers of elastomer material and made with fibers, advantageously but not exclusively carbon fibers.

More particularly, the sheet of fibers, preferably carbon fibers, according to the invention is comprised of a plurality of superimposed layers of fibers, in a number comprised between 2 and 8, preferably between 2 and 4, which are positioned one above the other and only connected each other with a stitching thread which is made to pass between the fibers in order to position one layer with respect to the adjacent layer.

With the term layer, in the present description, we mean a plurality of fibers laying substantially on the same plane and oriented substantially in the same direction.

The sheet obtained by the above-mentioned multilayer is substantially free of stiffness to flexional and compressive forces, and is able to accommodate and adapt itself, in a way disclosed in detail in the following, to deformations to which the adjacent layers of elastomeric material are subjected in the case that an earthquake occurs.

In a preferred form of embodiment, the fibers of one layer are differently oriented with respect to the fibers of the adjacent layer, thus obtaining a bi-directional structure in the case of two layers, or a multi-directional structure in the case of a plurality of layers.

Advantageously, as reinforcement elements it is also possible to use fabrics or layers of carbon fibers with a different elastic modulus or different resistance. Alternatively, fibers of other material can be used, for example aramid or glass. Moreover, according to the present invention, other geometries can be used, apart from a fabric intended as warp and weft, for example with a mesh structure, with a structure of bundles of threads of fibers disposed concentric, or a structure with a random disposition.

According to a characteristic feature of the present invention, the reinforcing fibers used in the seismic isolator are not preventively pre-tensioned or subjected to any other type of stiffening treatment.

The pre-tensioning is not required since, when a vertical load is applied to the isolator, the fibers, thanks to their arrangement in superimposed and multi-directional layers without a rigid connection between the layers, after an initial step in which they elongated due to the transversal dilation of the adjacent elastomeric layers, then enter in a tensioned condition so performing the confining and delimiting effect of the deformations.

Advantageously, the layers of elastomer material and the relative reinforcement elements in sheet form are glued to each other by means of a vulcanization operation that advantageously affects the overall structure.

A favorite solution of the present invention provides that the upper and lower end surfaces of the isolator are formed by relative layers of elastomer material.

The present invention allows to achieve a seismic isolator which is very effective in protecting a building from seismic activity and which, thanks to the use of sheets, also very thin, of fiber fabric, is very light, since it does not have the steel end plates used in the state of the art, nor the steel plates interposed between the elastomer layers. The fact that these metal plates are not present also eliminates all the problems concerning their gluing and the preparation and making of the connections between the isolator and substructure and between the isolator and the superstructure.

Moreover, the reduced weight of the isolator made according to the present invention consequently reduces the difficulty and costs of transport and installation.

Furthermore, the present invention is inexpensive and simple to make by simple superimposing the various components and then vulcanizing them. The carbon fibers, as we say before, do not need to be pre-tensioned nor to be subjected to any other kind of treatment, and therefore it is not laborious, as in the state of the art, to make the isolator according to the present invention.

These advantages of reduced weight and costs are particularly advantageous in any widespread application to civilian dwellings.

The isolator thus made can be easily shaped or cut into several parts, both during production and also subsequently, for example during installation, also in elongated form, so that it can be used under columns and masonry of various thickness and length. In this way, the present invention can be used in various types of building, for example the frame type or with masonry walls.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a three-dimensional view in separate parts of the isolator according to the present invention;

FIG. 2 is a three-dimensional view of the isolator according to the present invention;

FIG. 3 is a three-dimensional view of a carbon fiber fabric not pre-tensioned usable to make an isolator according to the present invention;

FIG. 4 is a plane view of the fabric in FIG. 3, cut in a rectangular shape;

FIG. 5 is a plane view of the fabric in FIG. 3, cut in a circular shape;

FIG. 6 is a schematic representation of a square section isolator according to the present invention installed under a column without any anchoring means;

FIG. 7 is a schematic representation of a rectangular section isolator according to the present invention installed under a masonry wall without any anchoring means;

FIG. 8 is a three-dimensional view of the isolator according to the present invention in a condition of deformation;

FIG. 9 is a three-dimensional view of the isolator according to the present invention in another condition of deformation;

FIG. 10 is a view of the isolator according to the present invention in a condition without seismic activity; and

FIG. 11 is a view of the behaviour of the isolator according to the present invention in a condition with seismic activity.

### DETAILED DESCRIPTION OF A PREFERENTIAL FORM OF EMBODIMENT

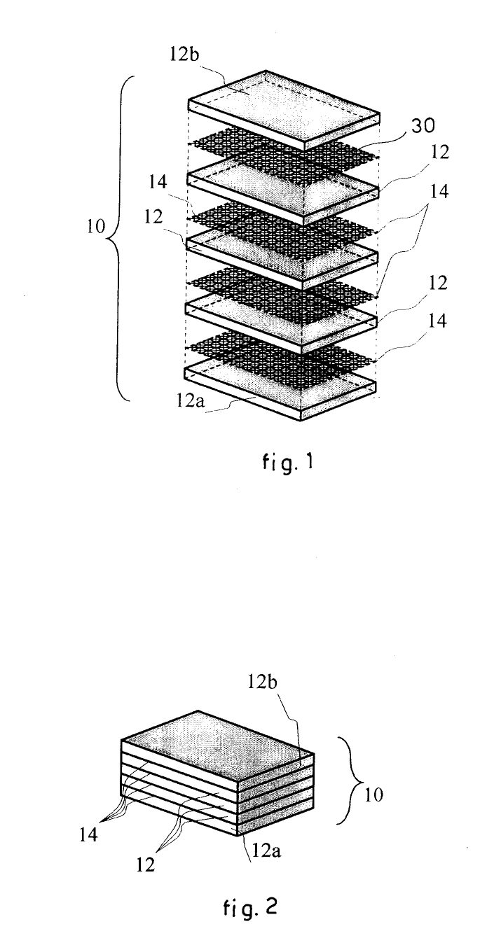

With reference to FIG. 1, a seismic isolator 10 according to the present invention is formed by five layers or sheets of elastomer material 12, positioned one on top of the other, and four relative reinforcement elements 14, consisting of sheets of fabric 16 with a carbon fiber base, which are disposed alternating, between one layer 12 and the other, so that the isolator 10 is delimited at the bottom by a respective lower layer 12a and at the top by a respective upper layer 12b (FIG. 2). As shown hereafter, the layers 12 and reinforcement elements 14, once positioned one on top of the other, are subjected to vulcanization, so as to be held together and to constitute substantially a single body.

As elastomer material different types of rubber can be used, such as natural rubber, polychloroprene rubber, neoprene.

The density and thickness of the layers of fabric 16 of carbon fiber can vary according to requirements, for example a surface density of fibers equal to 380 g/m² can be used, with an overall thickness of 0.212 mm, or a fabric with greater or lower density and thickness.

It is clear that the number of layers 12 and reinforcement elements 14 may vary, according to requirements, while it remains true that, preferably, said layers 12 and elements 14 are alternated and the isolator 10 is delimited above and below by the layers 12a and 12b.

Both the layers 12 and also the reinforcement elements 14 can be shaped in a desired shape, according to the requirements of the application.

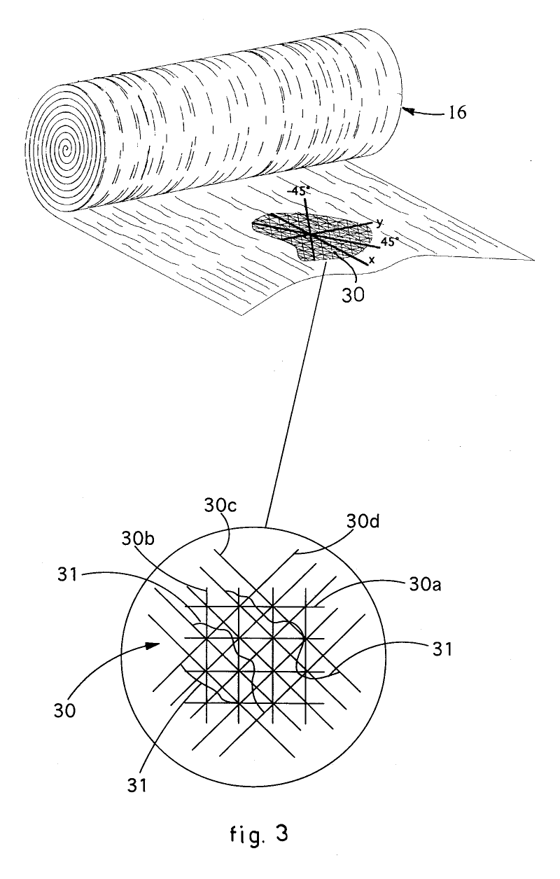

FIG. 3 shows the fabric 16 of carbon fibers 30 wound in a roll which is advantageously used to make the elements 14.

The reinforcement elements 14 according to the invention comprise, as said before, a sheet or fabric 16 made by a number of layers of fibers 30 placed one above the other, advantageously between 2 to 8 and more advantageously between 2 to 4.

As already said before, each layer comprises a number of fibers 30 laying substantially in the same plane and oriented substantially in the same direction, wherein each layer of fibers 30 is connected to the adjacent layer of fibers 30 only by a stitching thread 31, which however lets the fibers 30 substantially free to adapt themselves to stresses and deformations.

The carbon fibers 30 are advantageously disposed multi-directionally, i.e. the direction of the fibers 30 in one layer is different with respect to the direction of the fibers 30 in the adjacent layer. In this case, see the detail in FIG. 3a, the fibers 30 are oriented in four directions, inclined by about 45° one with respect to the other, that is, the fibers 30a parallel to the axis X, the fibers 30b parallel to the axis Y, the fibers 30c inclined by 45° with respect to the axis X and the fibers 30d inclined by 45° with respect to the axis Y. The carbon fibers in other embodiments can be disposed bi-directional, inclined in two directions, parallel to the axis X and the axis Y. The multi-directional solution is advantageous, since it reduces the level of anisotropy in the plane XY.

According to one form of embodiment, it is possible to position one on top of the other several layers of fabric, in contact with each other, rotated off-set one with respect to the other by a pre-determined angle, in order to further increase the isotropy in the plane XY.

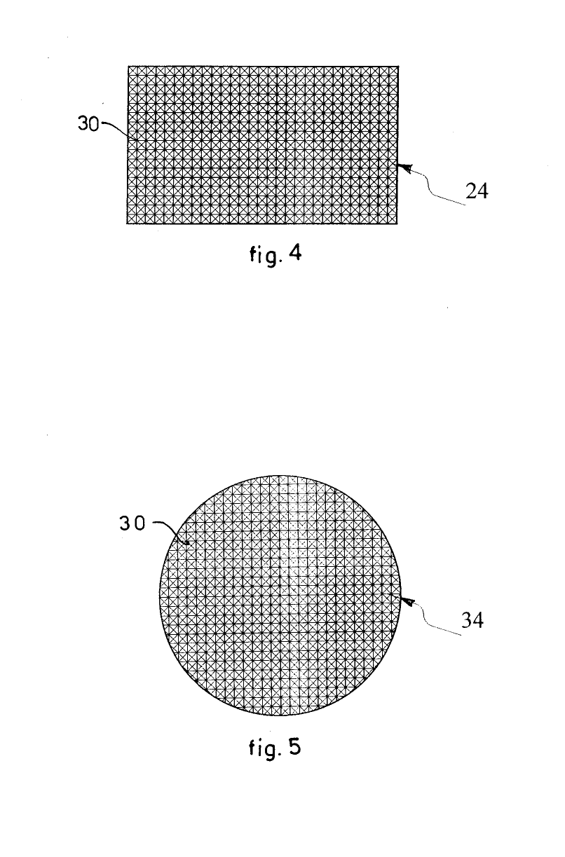

The fabric 16, like the rubber that makes up the layers 12, can easily be shaped into any desired form, for example to make an element 24 with a rectangular shape (FIG. 4), an element 34 with a circular shape (FIG. 5), or a square or elongated rectangular shape. Consequently, the isolator 10 too can also be made cubic, cylindrical, rectangular parallelepiped, more or less elongated.

In particular, the elongated rectangular shape is advantageous because it allows to obtain a seismic isolator that can subsequently be cut to size, in order to adapt to contingent requirements.

The isolator 10 is produced using a mold of the desired shape, for example square, circular, rectangular, elongated rectangular or other, into which the layers 12 alternating with the reinforcement elements 14 are inserted one on top of the other, with on the bottom the lower layer 12a and on top the upper layer 12b.

The layers 12 and the reinforcement elements 14 stacked in the mold are subjected to a pre-determined compression at a temperature and pressure able to cause them to be glued together by means of vulcanization.

In the vulcanization operation, the pressure can vary between about 10 MPa and 70 MPa, the temperature between about 100° C. and 200° C. and the time required for vulcanization between about 30 minutes and 150 minutes.

In this way, advantageously, it is not necessary to provide steel or wood plates at the ends in order to connect the isolator 10 with the substructure 18 and the superstructure 20.

The isolator 10 thus obtained is usable interposed between the substructure 18 and the superstructure 20 of a building to be protected from seismic activity.

The installation of the isolator 10 provides to effect a preliminary cleaning and roughening of the concrete surfaces of the superstructure 20 and the substructure 18 of the building which are intended for contact. Afterwards, the isolator 10 is positioned between the substructure and the superstructure.

Advantageously, since the isolator 10 does not need to be physically connected to the rest of the structure, it is not even necessary to provide anchoring elements for it.

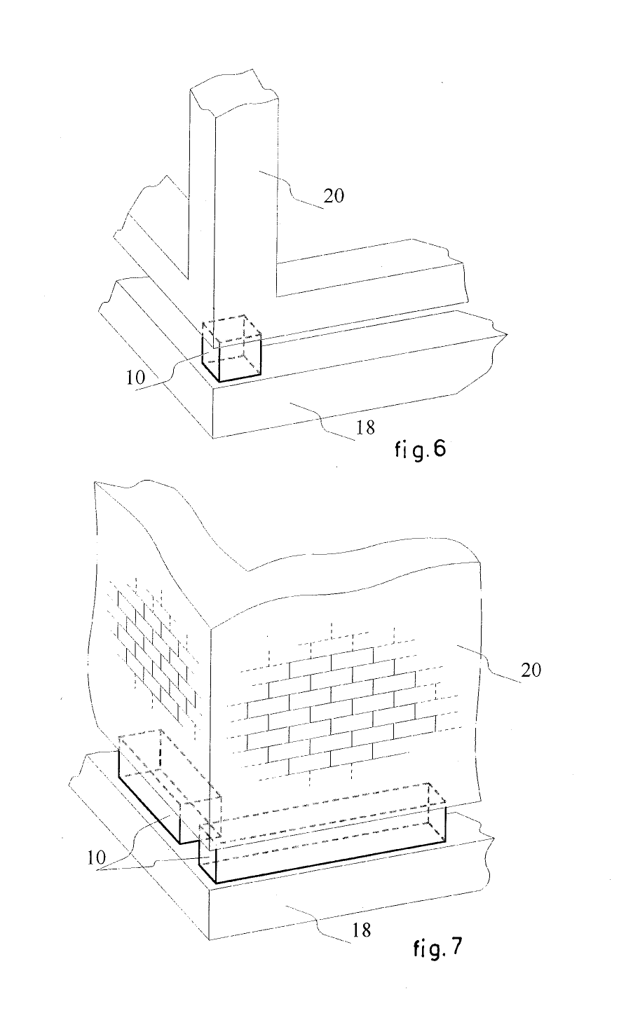

FIG. 6 shows the isolator 10 of cubic shape, installed, interposed between the substructure 18, consisting of foundations connected to the ground, and the superstructure 20, consisting of a frame type building. In the case of buildings with a frame-mounted structure, the isolators 10 are preferably disposed under the vertical bearing elements, as shown in FIG. 1 where the isolator 10 is located under a column.

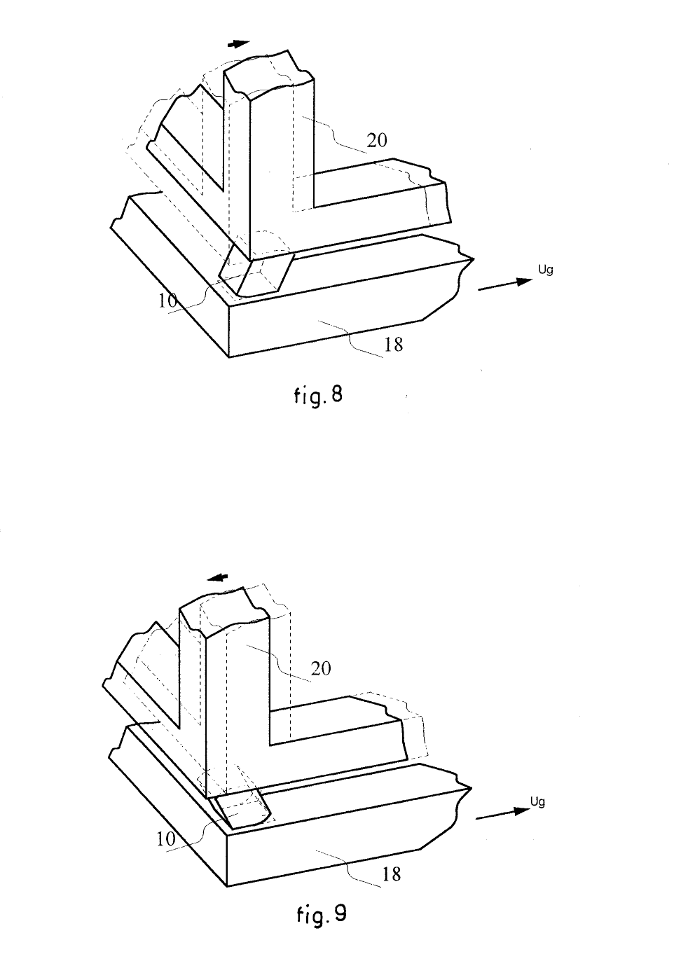

FIG. 7 shows the isolator 10 shaped like an elongated rectangular parallelepiped, installed, interposed between the substructure 18, connected to the ground, and the superstructure 20, consisting of a brickwork building. In the case of buildings with brick walls, the isolators 10 preferably have an elongated rectangular shape, that is, a shape mating with that of the bearing walls, also of an elongated shape.

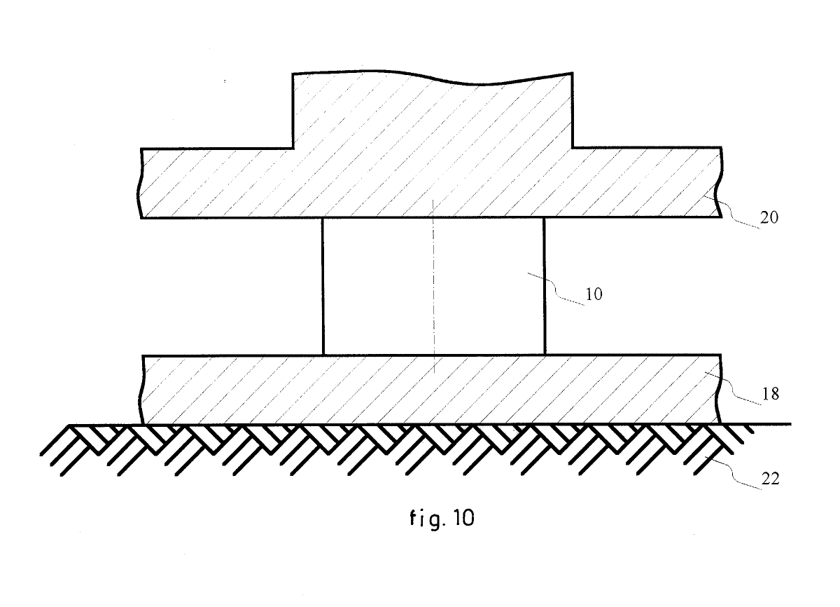

In inactive conditions, that is, without stresses deriving from seismic activity, the isolator 10 is not deformed, as shown in FIG. 10; in this case it can be seen that the substructure 18 rests on or in any case is constrained to the foundation ground 22.

When there are stresses deriving from seismic activity, the isolator 10 deforms. In particular, in FIGS. 8 and 9 it can be seen how the isolator 10 deforms due to the field of displacements, indicated by the arrows Ug, of the seismic activity, acting in the direction of the relative arrows and transferred by the ground through the substructure 18. Because of the earthquake, the substructure 18, solid with the ground, sustains great acceleration and, due to the effect of this acceleration, is subject to said field of displacements Ug, which determines in the isolator 10 a deformation of the bending-shearing type.

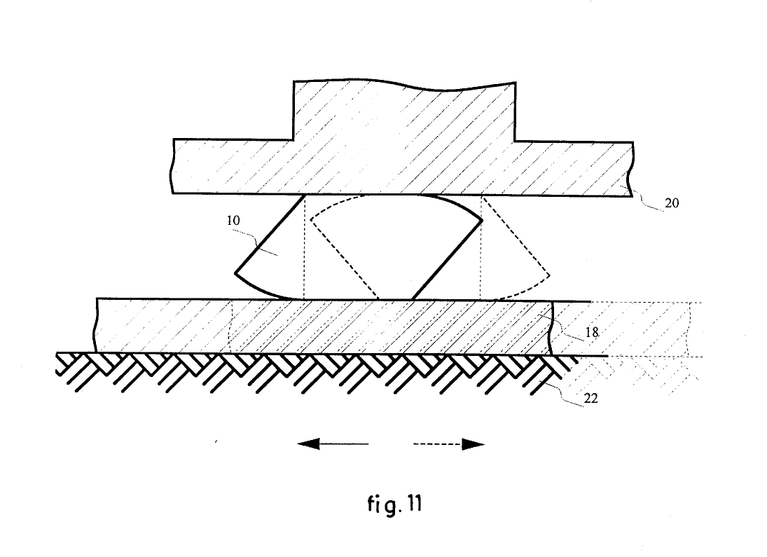

In FIG. 11 the isolator 10 can again be seen, positioned between the superstructure 20 and substructure 18, in deformed conditions following the earthquake. In particular, the continuous line represents the deformed profile in the case of movement of the ground 22 and of the substructure 18 towards the left, with respect to the inactive condition in FIG. 10, whereas the broken line represents the deformed profile in the case of a movement of the ground 22 and of the substructure 18 towards the right, with respect to the inactive condition in FIG. 10. From the FIG. 11 it can be seen that this typical deformation is due to the lack of anchoring means of the isolator 10 to the substructure 18 and to the superstructure 20, respectively, and to the fact that the reinforcing fibers 30 are free of stiffness to flexional and compressive forces and are disposed in a multi-directional orientation substantially without any definitive connection between superimposed layers.

It is clear that modifications and/or additions of parts and/or steps may be made to the seismic isolator and method as described heretofore, without departing from the field and scope of the present invention.

It is also clear that, although the present invention has been described with reference to some specific examples, a person of skill in the art shall certainly be able to achieve many other equivalent forms of seismic isolator and method, having the characteristics as set forth in the claims and hence all coming within the field of protection defined thereby.

1. A seismic isolator comprising:
at least two layers disposed one on top of the other and made of an elastomer material;
at least one reinforcement element in the form of a sheet, disposed between said layers and made of fibers, said reinforcement sheet being made by a number of layers of fibers placed one above the other, each layer comprising fibers disposed substantially in the same plane and oriented in the same direction, the fibers of one layer being differently oriented with respect to the fibers of an adjacent layer.

2. The seismic isolator as in claim 1, wherein the sheet comprises a number between 2 to 8 layers of fibers.

3. The seismic isolator as in claim 1, wherein the sheet comprises a number between 2 to 4 layers of fibers.

4. The seismic isolator as in claim 1, wherein said fibers are carbon fibers.

5. The seismic isolator as in claim 1, wherein said reinforcement element is formed by a plurality of sheets of fibers one on top of the other and rotated one with respect to the other by a pre-determined angle.

6. The seismic isolator as in claim 1, wherein said layers are glued to the relative reinforcement elements by means of vulcanization.

7. The seismic isolator as in claim 1, wherein a first of said layers is disposed below, to define the lower end of said isolator, and a second of said layers is disposed above, to define the upper end of said isolator.

8. The seismic isolator as in claim 1, wherein the seismic isolator is shaped according to a pre-determined shape selected from a group comprising cubic, curvilinear, rectangular parallelepiped and elongated rectangular parallelepiped.

9. A method of making a seismic isolator comprising:
inserting into a mold at least two layers of elastomer material positioned one above the other and at least one reinforcement element in the form of a sheet, disposed between said layers and made by means of fibers, wherein said sheet is made by a number of layers of fibers placed one above the other, each layer comprising fibers disposed substantially in the same plane and oriented in the same direction, the fibers of one layer being differently oriented with respect to the fibers of an adjacent layer;
compressing said layers and said at least one reinforcement element inserted into said mold at a temperature and pressure able to determine their reciprocal gluing through vulcanization.

10. The method as in claim 9, wherein a plurality of layers of elastomer material are inserted alternating with a corresponding plurality of said reinforcement elements in the form of a sheet.

11. The method as in claim 9, wherein, a lower layer of said layers is inserted first into said mold, and an upper layer of said layers of elastomer material is inserted last.
